(19) United States
(12) Patent Application Publication
(10) Pub. No.: US 2012/0094162 A1
(43) Pub. Date: Apr. 19, 2012

(54) BATTERY FOR ELECTRIC VEHICLE AND METHOD OF CHANGING BATTERIES

(76) Inventor: Laszlo Gyenes, Crowthorne (GB)

(21) Appl. No.: 13/318,299

(22) PCT Filed: Apr. 30, 2010
(86) PCT No.: PCT/GB2010/050717

§ 371 Date: Dec. 16, 2011

(30) Foreign Application Priority Data
Apr. 30, 2009 (GB) 0907389.1

(51) Int. Cl. H01M 2/10; H01M 10/42; H02J 7/00

(52) U.S. Cl. 429/97; 320/109; 429/100; 429/99; 29/763

(57) ABSTRACT

A rechargeable battery for powering an electric vehicle, the battery comprising at least one removable and replaceable electrically rechargeable cell, wherein the cell is encapsulated within a capsule compatible with transport along a pipeline.

This invention relates generally to electric vehicles (EV) and a battery for an EV, in particular an electrically powered vehicle and its associated battery. More specifically, although not exclusively, this invention relates to a system for recharging an EV and/or replacement or replenishment of batteries for such vehicles.

There is considerable interest in developing mainly battery powered vehicles such as passenger cars with appropriate charging arrangements. With internal combustion engine (ICE) vehicles a quantity of fuel energy sufficient to provide a range of 500 km or more can be taken on board very quickly. In contrast, ‘refuelling’ an EV is generally much slower and required more frequently because of the lower range provided by such vehicles. Each EV generally has a built-in battery charger and a cable to connect to a suitable mains electricity supply. Although very high charging rates, 15-20 minutes to full charge, have become possible for some lithium ion batteries, 6-12 hours to full charge is likely to be the normal rate at domestic or public charging points. This length of charging time is generally unacceptable for a vehicle needed for a long journey or a sequence of journeys that far exceeds its operating range of 100-200 km on a single charge. A battery exchange system has been proposed as a solution to this; swapping a depleted battery for a fully charged one at an “electric filling station”, as indicated, for example, by A refuelling infrastructure for an all-electric car fleet by R L Watson, L Gyenes and B D Armstrong. (1986) Transport and Road Research Laboratory, TRRL Research Report 66. Copies are obtainable from http://www.tri.co.uk/ and the Department for Transport http://www.berr.gov.uk/files/file48653.pdf).

The battery pack for an average electric passenger car may weigh some 250 kg to 300 kg. Advantageously and to provide good weight distribution and thus safe handling of the car, the battery pack could be specifically designed for each particular vehicle and therefore integrated into the structure. Thermal management of batteries in EVs is also essential for effective operation in all climates. This may also be integrated into the EV's cabin and powertrain temperature control system. In such applications, changing the battery pack will be far more time consuming and difficult than those used to in current ICE vehicles, and will require specialised handling equipment (as indicated, for example, by the department for Transport—http://www.berr.gov.uk/files/file48653.pdf). Moreover, every recharging station would need to carry considerable stocks of fully charged batteries. This would entail considerable financial outlay, which would have to be paid for by the end user.

U.S. Pat. No. 3,799,063 proposes one such system in which hydraulically actuated lifting arms are used to unload spent batteries and to load recharged batteries. Whilst such a system would be suitable for some battery types, the flexibility in configuring the battery location and accessibility in the EV would be extremely limited.

There is therefore a need for a battery exchange system that overcomes or at least mitigates the aforementioned issues. There is a more specific need for such a system that facilitates fast and simple exchange of battery cells.

Accordingly, a first aspect of the invention provides a rechargeable battery, e.g. suitable for use to power an electric vehicle, the battery comprising at least one removable and replaceable electrically rechargeable cell, wherein the cell is encapsulated within a capsule or carrier compatible with transport along a pipeline.

The solution of the present invention resides in leaving the battery casing on the EV but exchanging its battery cell or cells or module or modules instead, preferably within the time typically required to refuel an ICE vehicle.

The at least one cell may comprise two or more cells, but preferably comprises a plurality of removable and replaceable electrically rechargeable cells. The battery may further comprise a capsule or carrier comprising or including or containing the at least one cell. Preferably, the battery further comprises two or more capsules, e.g. a plurality of capsules, each capsule comprising or including or containing at least one cell, e.g. two or more such as a plurality of cells. More preferably, the battery further comprises a plurality of capsules, e.g. electrically interconnected capsules, each with a plurality of electrically rechargeable cells, e.g. in electrical contact with one another, encapsulated therein, wherein each capsule is preferably compatible with transport along a pipeline. One or more of the capsules, for example three capsules, may be encapsulated within a carrier.

The capsule or carrier may be compatible with transport along a pipeline by any propelling means, such as a pressurised fluid, an electromagnetic means or any other suitable means. Preferably, however, the capsule or carrier is compatible with pneumatic transport along a pipeline.

A second aspect of the invention provides a capsule of one or more electrically rechargeable cells suitable for use within a battery and carrier according to the first aspect of the invention.

The capsule may comprise one or more electrical terminals or connectors at either end thereof. Preferably, the capsule comprises a connector two electrical terminals at either end thereof. More preferably, a first of the terminals is at least partially surrounded by a second of the terminals, for example the first terminal may be radially nested within the second terminal. The capsule may comprise a male connector at a first of its ends and a female connector at a second of its ends. The male connector may comprise two concentric male connector elements, for example a projection surrounded at least in part by a curved and/or hollow, e.g. tubular, projection. The female connector may comprise two concentric female connector elements, for example radial wiper connector elements, e.g. a pair of curved and/or hollow, e.g. tubular, projections. The male and female connectors preferably cooperate to provide an interference fit and/or contact. The female connector may comprise two or more, e.g. a plurality, of resilient elements, which may be biased to provide an undersized or oversized tubular element for cooperation with the male connector. The wipers may be constructed from strips of connectors, e.g. beryllium copper connectors, which may be wrapped around the circumference of the capsule.

The capsule may comprise a switching means, for example to switch the contact between one or more pairs of the terminals, e.g. for facilitating or to facilitate, in use, a change in the connection configuration between the capsule and an adjacent capsule. The switching means may be configured to switch the connection between adjacent capsules from a series connection to a parallel connection and/or vice versa. Preferably, the switching means comprises one or more solid state switches, e.g. DC solid state switches.

One or more of the connectors or connector elements or terminals may be at least partly shielded by an electrically non-conducting collar. The capsule may incorporate a socket for remote control and/or means, such as plug means, to accommodate a solenoid operating plug.

The capsule preferably comprises a receptacle, which may be openable, in which the cells are housed and/or at least one collar, for example a flexible or rigid and/or heat conducting collar, around at least part of the capsule, e.g. a circumferential collar which may surround the capsule, for facilitating transport, in use, along a pipeline. The capsule may advantageously include a pair of collars. The at least one collar is preferably configured to cooperate with a pipeline, e.g. through which the capsule may be transported, to guide and/or locate and/or substantially or functionally seal therewith. For example, the at least one collar may comprise a projection or ridge, e.g. a circumferential and/or radial and/or outwardly extending projection or ridge.

A third aspect of the invention provides an encapsulated two or more, e.g. a plurality of, capsules as described above.

The battery or encapsulated two or more capsules may comprise first and second capsules. The first capsule type may comprise an electrical terminal connector configured to cooperate with the electrical terminal connector of another first capsule type to provide a series connection. The second capsule type may comprise an electrical terminal connector configured to cooperate with the electrical terminal connector of another second capsule type to provide a series connection. The electrical terminal connectors of the first and second capsule type may be configured to connect the first and second capsules in parallel.

The capsule or encapsulated plurality of capsules may be capable of insertion, e.g. pneumatic insertion, into and removal from a rechargeable battery as described above. One end of the encapsulated plurality of capsules may be vented to atmosphere and/or the other or remote end thereof may be sealed, e.g. atmospherically sealed.

A fourth aspect of the invention provides a train of a plurality of mutually adjacent encapsulated cells as described above. Preferably, respective adjacent such encapsulated pluralities of the train may be mechanically and/or electrically connected.

A fifth aspect of the invention provides an electrically powered vehicle comprising a rechargeable battery and/or a capsule and/or an encapsulated plurality of capsules and/or a train of a plurality of mutually adjacent encapsulated cells as described above.

The vehicle may further comprise a heat plate within which encapsulated pluralities of cells as described above can be located. The vehicle may further comprise at least one displacement pipeline, e.g. at least one pneumatically compatible displacement pipeline, through which the capsules or encapsulated pluralities of capsules may be transported to and from its rechargeable battery or batteries.

A sixth aspect of the invention provides a service and/or charging station, e.g. an electric vehicle service and/or charging station, compatible for use with an electrically powered vehicle, or pneumatically compatible displacement pipeline thereof. The station preferably comprises a charging receptacle within which the capsules and/or encapsulated pluralities of cells as described above can be stationed, e.g. temporarily stationed, for recharging. The station may further comprise one or more pneumatically compatible displacement pipelines configured or able to couple with the electric vehicle, or pneumatically compatible displacement pipeline thereof, in a manner to receive and transport one or more of the capsules or encapsulated pluralities of cells.

A seventh aspect of the invention provides a repository of capsules or multiple encapsulated pluralities of cells as described above. The repository is preferably configured or adapted for use with a station as described above, e.g. in that it comprises pipelines in pneumatic communication with the station and/or a stock of capsules or encapsulated pluralities of cells.

An eighth aspect of the invention provides a system of apparatus capable of withdrawing, e.g. pneumatically withdrawing, from an electric vehicle rechargeable battery one or more encapsulated cells or cell capsules and/or replacing with replacement charged or operational encapsulated cells or cell capsules. The system preferably comprises a station as described above, e.g. in pneumatic communication with a repository as described above and/or in combination with an electric vehicle as described above.

A ninth aspect of the invention provides a method of charging or recharging at least one rechargeable battery within an electric vehicle, e.g. using one or more of the aspects of the invention described above. The method preferably comprises removing, e.g. pneumatically removing, from said battery at least one discharged, partly discharged or faulty cells or cell capsules or encapsulated plurality of capsules or cells as described above. The method may further comprise replacing, e.g. pneumatically replacing, it with another like such cells or cell capsules or encapsulated plurality of capsules or cells in a charged and/or otherwise operational state.

The method may advantageously involve the use of a station as described above and/or the use of a repository as described above.

Other optional and preferred features of the invention in all its aspects will be apparent to those skilled in the art.

Embodiments of the invention will now be described by way of example only with reference to the accompanying drawings in which:

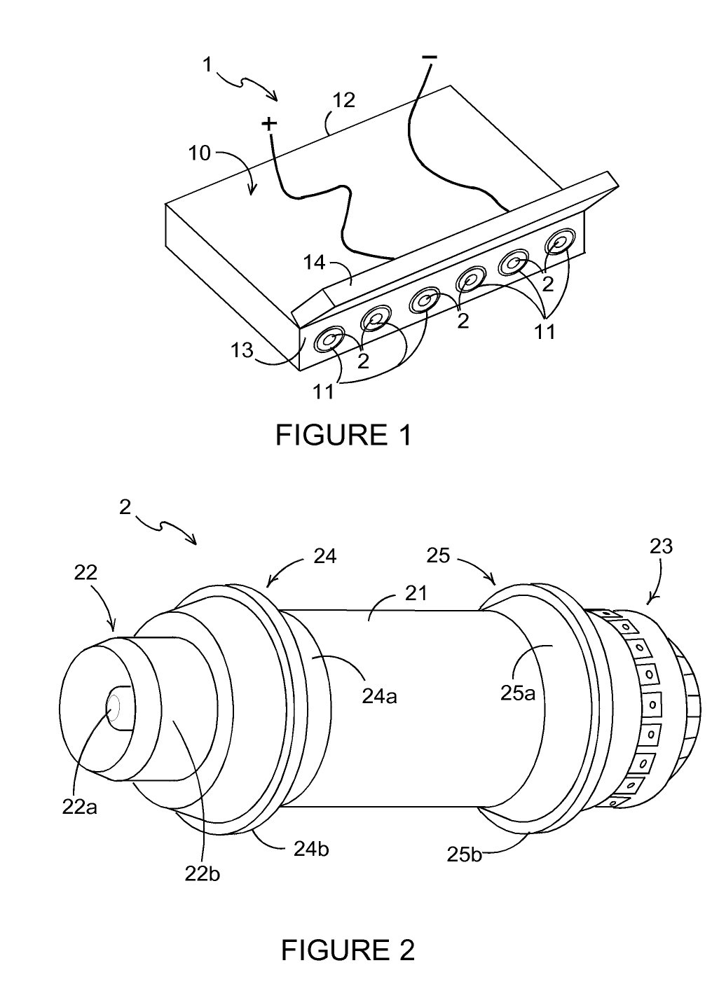

FIG. 1 is a perspective view of a battery according to a first embodiment of the invention;

FIG. 2 is a perspective view of a capsule for use in the battery of FIG. 1 showing the male electrical connector;

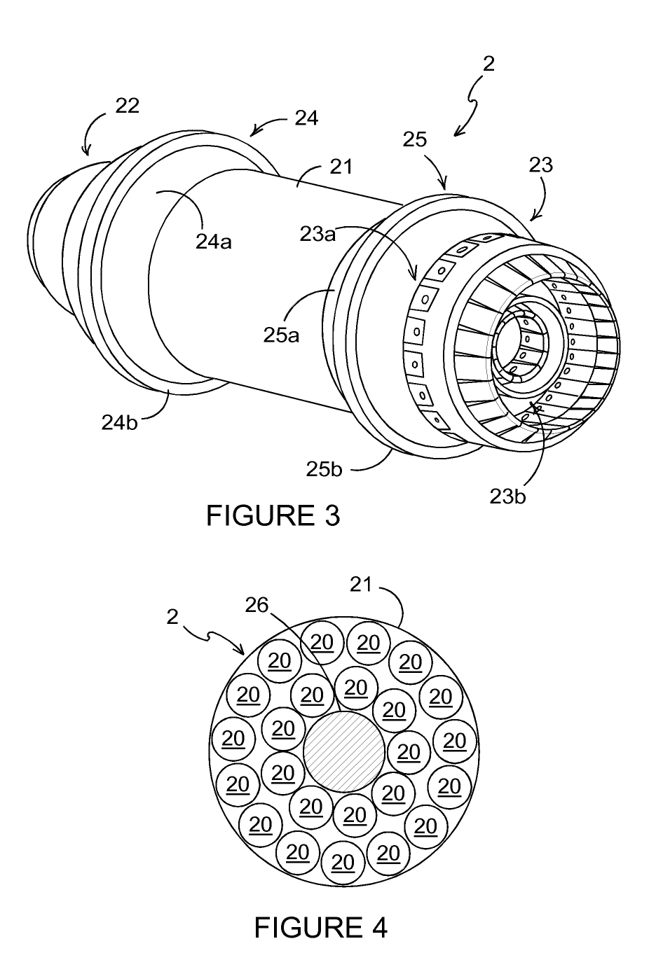

FIG. 3 is a similar view to that of FIG. 2 showing the female electrical connector;

FIG. 4 is a schematic cross sectional view of the capsule of FIGS. 2 and 3 through a central portion thereof;

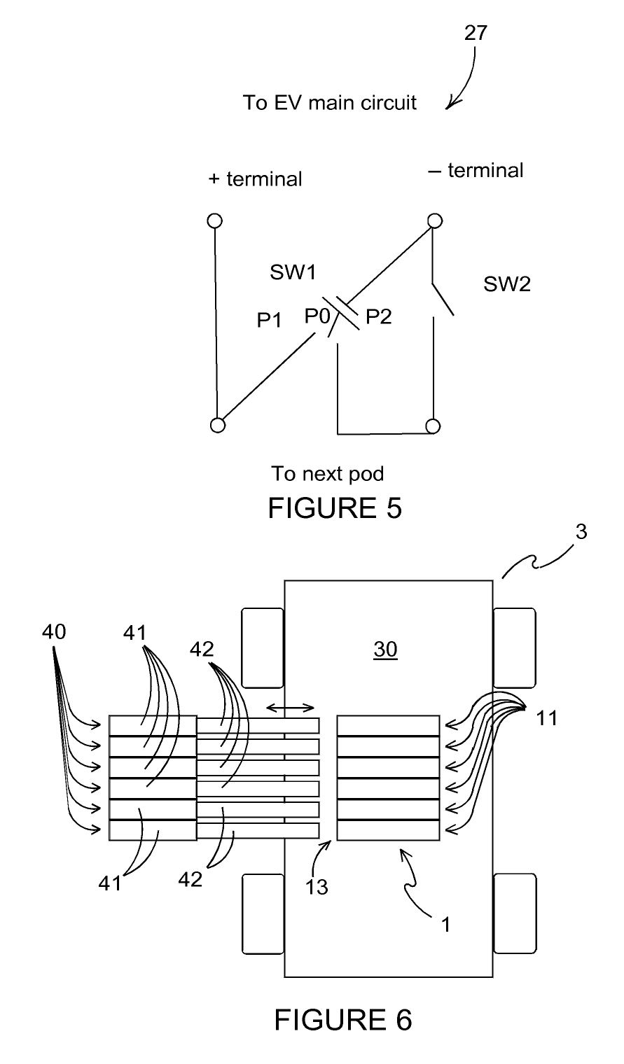

FIG. 5 is a schematic illustrating the switching means incorporated within the core of the capsule of FIGS. 2 to 4;

FIG. 6 is a schematic illustrating the releasable attachment of the filling tube of a service and/or charging station with the battery of an electric vehicle according to the invention;

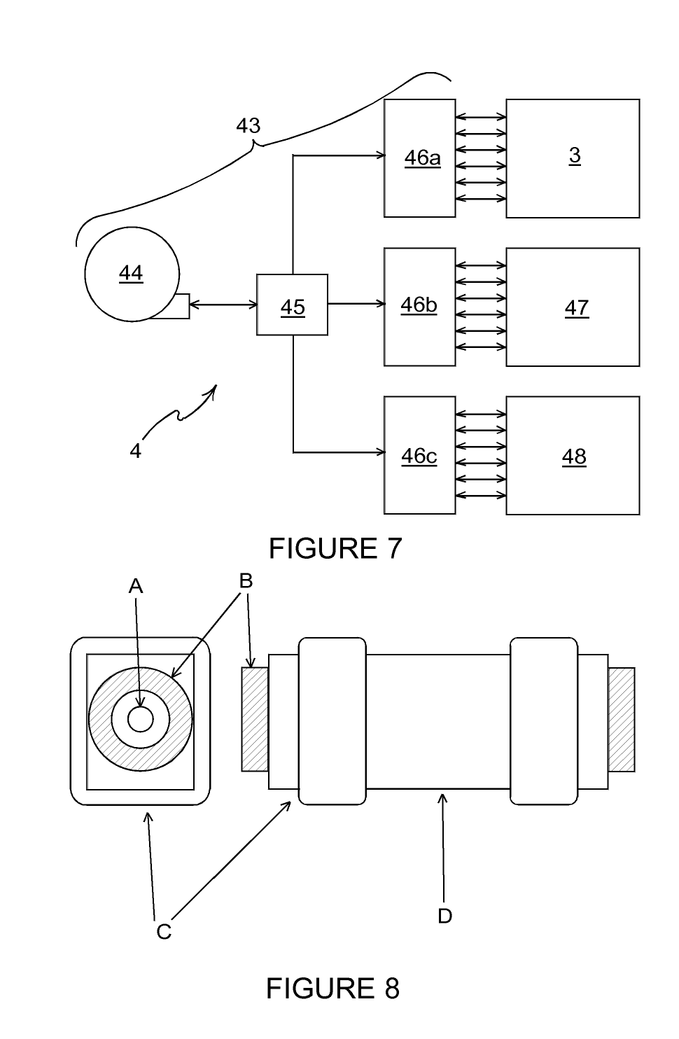

FIG. 7 is a schematic illustrating a system of apparatus according to the invention;

FIG. 8 is an end—and side—elevation of a non terminal flexibly connected pneumatically compatible battery capsule according to a second embodiment of the invention;

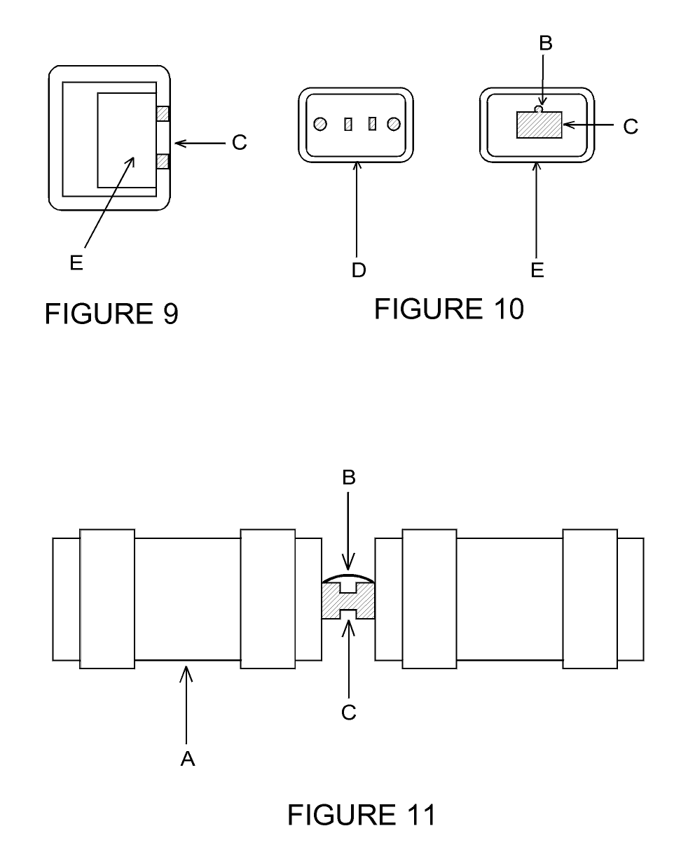

FIG. 9 is also an end-elevation of a front terminal pneumatically compatible battery capsule, capable of attachment in electrical contact with the capsule of FIG. 8,

FIG. 10 is an end-elevation of a front terminal pneumatically compatible battery capsule, capable of attachment in electrical contact with the capsule of FIG. 10, and a non terminal pneumatically compatible battery capsule;

FIG. 11 is side elevation of a non terminal rigidly connected pneumatically compatible battery capsule;

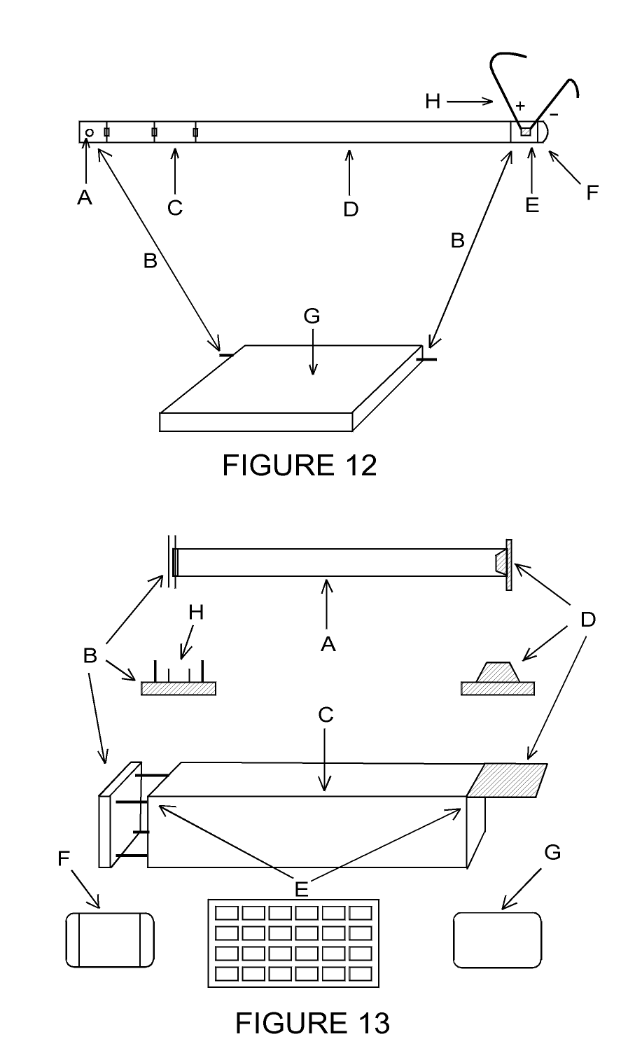

FIG. 12 is an isometric arrangement of an electric vehicle pneumatically compatible battery tube of multiple capsules within and schematically outside of a battery temperature control jacket;

FIG. 13 is an isometric arrangement of an electric vehicle pneumatically compatible battery tube of multiple capsules within and schematically inside a battery casing, housing the battery tube and battery temperature control jacket or cooling jacket; and

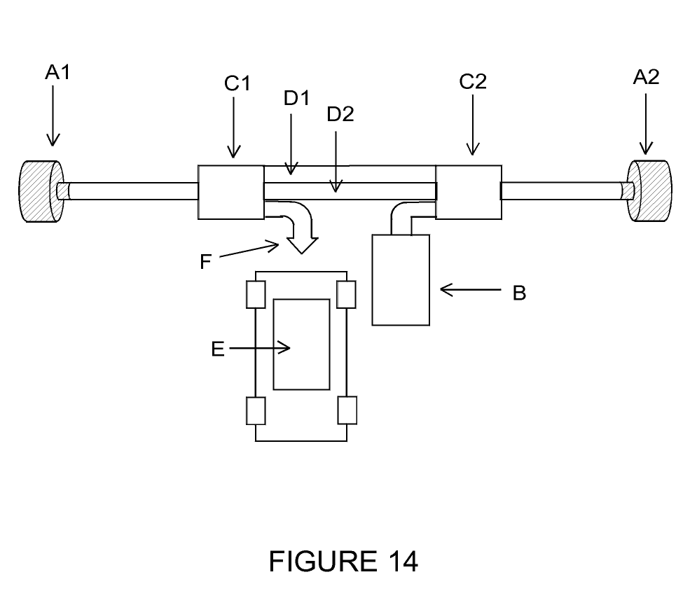

FIG. 14 is a schematic diagram of a four step modular battery exchange.

Referring now to FIG. 1, there is shown a rechargeable battery 1 for use to power an electric vehicle. The battery 1 includes a casing 10 incorporating an array of six tubes 11, a closed end 12, an open end 13 and a hinged lid 14 for selectively closing the open end 13. The tubes 11 are arranged to releasably receive a train of three battery pods or capsules 2. The closed end 12 incorporates a closeable vent (not shown) and a connector (not shown) aligned with each tube 11. The lid 14 also incorporates a seal and connector (not shown) configured to be aligned with each tube 11 and to apply an axial pressure on the train of battery capsules 2 and to substantially seal the casing 10 when the lid 14 is in a closed condition. The casing 10 also includes a cooling means (not shown) in this embodiment to maintain the temperature of the tubes 11 within an optimum range.

Referring now to FIGS. 2 to 5, each capsule 2 encapsulates a plurality of electrically rechargeable cells 20 within a tubular body 21 with a first connector 22 at one end, a second connector 23 at the other end and one collar 24, 25 adjacent each end. The first connector 22 includes two concentric connector elements 22a, 22b, namely a cylindrical projection 22a surrounded by a tubular projection, both of which includes a lead in taper. The second connector 23 also includes two concentric connector elements 23a, 23b, radial wiper connector elements 23a, 23b in this embodiment, both of which are in the form of tubular projections 23a, 23b, wherein one is radially nested within the other in this embodiment. Each connector element 23a, 23b of the second connector 23 includes a plurality of resilient elements that are biased to provide an undersized tubular element 23a, 23b for cooperation with a respective one of the connector elements 22a, 22b of the first connector 22. These resilient elements of the connector elements 23a, 23b of the second connector 23 are constructed from wrapped strips of beryllium copper connectors.

One of each pair of connector elements 22a, 22b and 23a, 23b incorporates a positive terminal 22a, 23a and the other of each pair 22a, 22b and 23a, 23b incorporates a negative terminal 22b, 23b.

The tubular body 21 is formed of moulded plastics material in this embodiment and is in the form of an openable receptacle that houses five layers of twenty four cells 20 and a core 26 that electrically connects the first connector 22 to the second connector 23 via the cells 20. The core 26 includes a cooling means (not shown) for controlling the temperature of the cells 20 and a switching means 27, as shown FIG. 5, that is remotely activated and that incorporates an internal high current DC solid state switch in this embodiment. The switching means 27 is configured to switch, when required, the connection between interconnected capsules from a series connection to a parallel connection and vice versa. This is achieved by swapping the polarity of one of the pairs of terminals 22a, 22b and 23a, 23b using the switching means 27. More specifically, where SW 1 is in position P1 and SW 2 is closed, this provides a parallel connection in relation to other capsules 2 with the same setting. When SW 1 is in position P2 and SW 2 open for all capsules, except for the trailing pod with SW 1 in position P1, this provides a series connection. When SW 1 is in position P0 and SW 2 is open, the internal circuit is open.

In use, to form a train of capsules 2 the first connector 22 of each capsule engages the second connector 23 of an adjacent capsule with sufficient interference to ensure a good electrical contact without impeding significantly the disengagement thereof. The engagement of adjacent connectors 22, 23 is also configured to provide sufficient flexibility to allow some angular displacement between adjacent pods.

When a train of capsules 2 is located within one of the tubes 11 of the battery 1, one of the connectors 22, 23 of the first capsule 2 in the train engages the respective connector (not shown) of the closed end 12 of the casing 10, while one of the connectors 23, 22 of the last capsule 2 of the train is exposed via the open end 13 of the casing 10. The lid 14 is then closed and the respective connector (not shown) of the lid 14 engages the exposed connector 23, 22 to provide a functioning battery.

Each collar 24, 25 is in the form of a circumferential ridge having a cross-section substantially in the shape of a truncated cone and is formed in two parts 24a, 24b and 25a, 25b. The first part 24a, 25a corresponds to the base of the triangular cross-section and is formed integrally with the body 21. The second part 24b, 25b is moulded onto the first part 24a, 25a, overmoulded during the moulding process in this embodiment, and is formed of a low friction plastics material suitable for providing both a seal between the capsule 2 and the tube 11 and to reduce friction of the capsule against the tubes 11 during their insertion and removal. The collars 24a, 24b, 25a, 25b are also used to guide the capsules 2 to ensure that adjacent capsules are aligned when they come into contact, thereby ensuring proper engagement of the connectors 22, 23.

Referring now to FIG. 6, there is shown a vehicle 3 incorporating the battery 1 of FIG. 1. As shown, the battery 1 is centrally stored within the floor pan 30 of the vehicle 3 in order to provide as low of a centre of gravity as possible. The battery 1 is at a slight angle and orientated such that each tube 11 extends transversely along the floor pan 3 with the open end 13 thereof accessible from one side of the vehicle 3 for refilling using a respective pneumatic pipe 40 of a charging station 4. Each pneumatic pipe 40 of this embodiment includes a flexible portion 41 connected to a repository of capsules 2 and a rigid portion 42 for connection with the battery 1 of the vehicle 3. The flexible portion 41 is configured for limited flexibility to ensure a minimum bend radius is maintained, thereby to ensure free movement, in use, of the capsules 2 therealong.

FIG. 7 shows a schematic illustration of the charging station 4, which includes a pipework system 43 incorporating a pneumatic source or reversible blower 44, a three way control device 45, three six way control devices 46a, 46b, 46c, a first rack 47 and a second rack 48. The source 44 is pneumatically connected to the three way control device 45, which in turn interconnects the three six way control devices 46a, 46b, 46c. A first six way control device 46a is pneumatically connected, in use, to the vehicle 3, while each of the other two six way control devices 46b, 46c is pneumatically connected to a respective one of the first and second racks 47, 48.

In use, the vehicle 3 will enter a service station (not shown) and position itself next to a charging station 4. In this embodiment, a front wheel of the vehicle 3 is then located in a retractable chock (not shown), the charging station reads an information storage means that is incorporated in the vehicle 3 to determine the vehicle's registration details and the charging station automatically disables the vehicle's power system to prevent the driver (not shown) from inadvertently driving away while the vehicle 3 is connected to the charging station 4. The lid 14 of the battery casing 10 is then opened to expose the trains of capsules 2, the vents (not shown) in the closed end 12 are opened, the pipes 40 are connected to the tubes 11 and the driver (not shown) is able to select the amount of charge required.

The source 44 is then activated to apply suction to the first six way control device 46a via the three way control device 45, thereby extracting the spent capsules 2 from the battery 1 of the vehicle 3. The source 44 is then reversed to apply a positive pressure and the pipework system 43 is configured to divert the spent capsules 2 via the three way control device 45 to the second six way control device 46b and into the first rack 47. When this transfer is complete, the source 44 is reversed again and the pipework system is reconfigured to apply suction to the third six way control device 46c to extract fresh charged capsules 2 from the second rack 48. The source 44 is then reversed yet again to apply a positive pressure and the pipework system 43 is reconfigured to divert the fresh capsules 2 via the three way control device 45 to the first six way control device 46a and into the vehicle 3. It will be appreciated that the system 43 may be configured to control adjustably the extent to which the vents (not shown) are opened in order to provide a cushioning effect as the capsules 2 are delivered into the battery 1 or at a predetermined time therebefore.

The above steps in relation to disabling the vehicle and connecting it to the charging station are then performed in reverse and the driver (not shown) drives a re-charged vehicle out of the service station. Payment may be made by any known method and/or by virtue of the aforementioned information storage means. Spent capsules 2 may be sent to an on-site or off-site recharging station (not shown). Additionally or alternatively, the recharging station (not shown) may comprise any suitable energy source such as nuclear or coal powered, but preferably the recharging station (not shown) incorporates one or more renewable energy sources such as wind turbines, photovoltaic solar cells, tidal energy source or any other suitable energy source.

It is estimated that a small to medium size electric powered vehicle according to the invention will be capable of travelling over 100 miles without the need for charging. These estimates are based on a vehicle 3 incorporating an electric motor equivalent to a standard 1.4 to 1.8 litre petrol engine with 70 to 120 brake horse power capable of propelling the vehicle from 0 miles per hour to 60 miles per hour in under 12 seconds. The battery described in the preferred embodiment is preferably configured to supply between 10 kWh and 30 kWh, more preferably 16 kWh to 24 kWh, at between 200 volts and 500 volts, more preferably 300 volts to 400 volts, of direct current electricity, e.g. to the electric motor of the vehicle 3. Each capsule preferably has a capacity of between 0.2 kWh and 5 kWh, preferably between 0.5 kWh and 2 kWh and more preferably between 0.90 kWh and 1.5 or 1.34 kWh. Each capsule may, for example, have external dimensions of 115 mm in diameter and/or 400 mm in length. The cells 20 are preferably high energy density cells 20 and/or may comprise any suitable rechargeable cells, for example Panasonic (RTM) 18650 cells. Preferably, the mass of each capsule is less than 10 kilograms, for example less than 8 kg, e.g. less than 7 kg such as 6.3 kg.

Referring now to FIGS. 8 & 9, a ‘key to the reference letters is as follows:
A—Location of airtight current carrying lead on non-terminal capsules
B—Elastometer ring
C—Low friction heat conducting collar
D—Plastic pneumatic battery capsule (lids front and back)
E—Remote control socket and entry holes for solenoid operated plugs

A ‘key’ to the reference letters used in FIG. 12 is as follows:
A—Air vents
B—Plastic electrically insulating tube
C—Battery capsule
D—Heat conducting metal tube, open (right) crossbar stopper (left)
E—Airtight solenoid operated plug
F—Lockable cap over entry/exit porthole
G—Battery temperature control jacket
H—Connections to battery circuit

A ‘key’ to FIGS. 10 & 11 reference letters is as follows:
A—Rigidly connected capsules
B—Flexible electrical chord
C—Spherical 3D rolling joints
D—Front end of terminal capsule with socket holes and guiding holes
E—Front and back of non terminal capsule view of B and C

A ‘key’ to the reference letters used in FIG. 13 is as follows:
A—Pneumatic battery tube, housing pneumatic battery capsules
B—Retractable motorised lid, incorporating plugs and battery connections
C—Battery pack casing, housing pneumatic battery tubes and cooling jacket
D—Battery exchange lid, incorporating elastomer bumpers
E—Portholes to pneumatic battery tubes
F—Porthole with capsule stopper bar at battery connection end
G—Open porthole where capsule pipeline is attached
H—Elastomer mounted ‘quick-couple’ guiding pins and twin electric plug

FIG. 12 & FIG. 13 represent the top of an EV pneumatic battery tube located inside battery temperature control jacket. Each tube can house 10+1 pneumatic battery capsules.

For flexible mechanical capsule connection, the location of plug is at the far end of the battery tube on battery charging rack with permanent attachment of pneumatic capsule pipeline at the entry/exit porthole.

For rigid mechanical capsule connections, there are sockets at either end of the battery capsule train and the air pressure assisted electrical connections are made at the far end of entry/exit portholes.

The EV battery is packaged using battery capsules compatible with pneumatic pipeline transport. For an average passenger car, 10-20 battery cells are assembled into plastic pneumatic battery capsules, these battery capsules are packed into EV encapsulated pneumatic battery capsules (FIGS. 8 & 9, FIGS. 10 & 11, Device 1), such capsules are then connected electrically and mechanically to form EV encapsulated pneumatic battery capsule trains (Device 2), short enough to be housed in EV pneumatic battery tubes (FIG. 12, FIG. 13, Device 3) on board of the EV. The encapsulated and suitably housed discharged battery pack/faulty battery pack can be exchanged for fully charged battery pack/battery pack in good working order from EV pneumatic battery charging rack (Device 4) via pneumatic capsule pipelines at a battery exchange or battery service stations, in less than 5 minutes.

At a battery exchange station or a battery service station, the EV is parked at a battery exchange bay/battery service bay. The battery pack is electrically isolated, portholes at the back or at the front of the vehicle are opened. For an average passenger car, there could be up to 24 portholes leading to the same number of EV pneumatic battery tubes. Flexible, 1-2 m long and 0.75 m bend radius of curvature, pneumatic pipelines are manually attached by airtight coupling to each porthole. These pipelines are permanently fixed to rigid pneumatic pipelines that lead from the 24 EV pneumatic battery tubes on board of EV to the same number of EV pneumatic battery tubes, located inside EV pneumatic battery charging rack, via a set of junctions equipped with electromechanical points or diverters (ref. 4, ref. 5, ref. 7)

The air pressure inside each pipeline is regulated by independent air supply. The EV pneumatic battery capsule trains travel at 10 m/sec and decelerate gently to a stop on arrival to their destination. The sequence of microprocessor controlled operations are illustrated in FIG. 14 and are as follows:

Step 1: The air supply is adjusted between the first EV porthole and siding Number 1, creating a pressure difference between the near-porthole side and the off-porthole side of the first discharged battery capsule train The pressure difference drives the battery capsule train, carrying discharged battery modules, via a set of junctions to siding Number 1.

Step 2: The air supply is adjusted between the first battery charging rack porthole and siding Number 2, creating a pressure difference between the near-porthole side and the off-porthole side of the first charged battery capsule train The pressure difference drives the battery capsule train, carrying charged battery modules, via a set of junctions to siding Number 2.

Step 3: The air supply is adjusted inside siding Number 1, creating a pressure difference between the ends of the battery capsule train, located inside the siding. The pressure difference drives the battery capsule train, carrying discharged battery capsules, via a set of junction to the first battery tube on the battery charging rack.

Step 4: The air supply is adjusted inside siding Number 2, creating a pressure difference between the ends of the battery capsule train, located inside the siding. The pressure difference drives the battery capsule train, carrying fully charged battery capsules, via a set of junctions to the the first battery tube of the EV.

This process is repeated for each of pipelines, until the entire discharged battery pack has been exchanged for a fully charged battery pack or the faulty battery pack has been exchanged for a battery pack in good working order. The flexible pneumatic pipelines are disconnected, portholes are closed and the battery pack circuit is closed, so ending the exchange process. As the pneumatic battery capsule trains travel at 10 m/sec, and if the operations are consecutive, they need not be, it would take less than 5 seconds for each capsule train to travel to and from the EV, given that the battery charging rack is located in the vicinity of the battery exchange bay. Battery exchange, including parking, pipes connection and disconnection should be completed within the time required to refuel an ICE vehicle.

If the next EV arrives before the previously exchanged battery pack is fully charged or replaced, the exchange process would take place using the next battery pack on the battery charging rack. If packs are recharged or replaced within the hour, 10 battery packs per bay would be sufficient to meet peak demand.

3. Devices

A tentative battery pack is used to check the feasibility of modularised battery exchange process via pneumatic pipelines using Devices 1, 2, 3 and 4.

3.1 Device 1

Small batches of 16 cylindrical 18650 type lithium ion cells, wired in parallellseries, are packed together with their associated electronic cell protection devices to form a 150 Wh nominal energy capacity. All cells are the same capacity (mAh) and same state of charge and all packs are the same capacity (mAh) same voltage and same state of charge. The batches of battery capsules are placed in a rectangular, 15-20 cm long 50 square cm cross section area, EV Pneumatic Battery Capsules (Device 1) and wired to the terminals inside the capsule. Practical design features of the terminal and non-terminal capsules are shown in FIGS. 8 & 9 and FIGS. 10 & 11. Conventional cylindrical capsules are liable to rotate inside cylindrical pipelines during transit, which would change the orientation of capsules and may impact upon design of the necessary electrical contacts.

3.2 Device 2

A batch of 10 capsules, packed with 160 high energy density lithium ion cells, connected in parallellseries and a terminal capsule form a EV Pneumatic Battery Capsule Train (Device 2) of 1.5-2 m long and 1.5 kwh nominal energy capacity, weighing about 10 kg.

For capsules of flexible mechanical connections, the terminal capsule at the front end of the battery capsule train, as viewed from the entry/exit portholes of the EV, houses the remote control DC terminal socket, cell monitoring and cell control devices, an actuator, the train's own power supply and a wireless communicating device. The device communicates the state of battery capsules to the central processor unit of EV battery management system and to the central processor unit of the EV Pneumatic Battery Charging Rack (Device 4) throughout the exchange process. The actuator signals a proximity switch on the EV/Device 4 to insert a solenoid-operated plug into the DC socket on completion of the exchange process. At the beginning of the air evacuation process, the solenoid operated plug (see also Device 3) is withdrawn, when all the battery capsule trains have been electrically isolated. Electric isolation, the disconnection of the battery circuit by the remote control DC socket, is activated by a command signal from the central processor unit of the respective battery management systems. At the end of the battery exchange process, the circuit is reconnected. The required design standard for the connectors may vary because high power connectors are not designed to be disconnected and reconnected on a regular basis.

For capsules of rigid mechanical connections the battery connection procedure is altogether different and is described in Section 3.3

The individual plastic capsules rely on a low-friction collar in the vicinity of each end to provide both a seal between the capsule and the pipe wall, and to reduce friction of the capsule against the pipe wall. Capsule dimensions, stiffness and length of current carrying leads are chosen also to ease the passage of the battery module train through pipelines with estimated bend radius of curvature to be maintained at around 0.75 m. The choice of stiff, very high current carrying leads may limit the ability of the capsules to negotiate sharp bends. When the capsules are in contact, short and flexible leads should neatly tuck into the space between the elastomer rings (see FIGS. 8 & 9). In transit, the tension on the leads should be minimal, unless there are obstructions in the pipeline. Untreated static metal-to-metal coefficient of friction in a horizontal tube is 0.65, so the static resisting force on a 10 kg capsule train is 63.7 N. The maximum force that can be exerted by atmospheric pressure on the 50 sq. cm cross section capsule train at the far end in each tube is 10.133˜50=5 06.65 N. Hence a 10-20% reduction of air pressure by a blower in reverse action at the near end of the tube could accelerate the capsule train and propel it to its destination. Low- friction collars would require even less air pressure by a blower.

The efficiency of lithium ion cell is remarkably high, 99% at low discharge rate and at high discharge rate it remains above 90% (ref. 8). If the heat generated inside each capsule is always less than 15 watts, the thermal conductivity of capsule collars, through which most of that heat will be conducted to the walls of Device 3, should not be less than 0.45 W/mK.

3.3 Device 3

Up to 24 EV Pneumatic Battery Capsule Trains, each weighing about 10 kg, are housed in identical longitudinally oriented, low friction heat conducting EV Pneumatic Battery Tubes (FIG. 12, FIG. 13, Device 3), and are located in a temperature control jacket, in 2 rows of 12 or 3 rows of 8 or 4 rows of 6 which is a part of the EV's battery thermal management system.

For capsules of flexible mechanical connections, the far end of each tube, away from the exit/entry porthole, is maintained at atmospheric pressure through vents. The near end of the tube is fitted with an airtight heavy-duty solenoid-operated plug, providing electrical connection to the rest of the battery circuit and for pinning down the leading capsule. The capsules are spring loaded between the pins at one end of the tube, and the crossbars at the other end of the tube on board of EV using compressed air in the final stage of the exchange process. This is necessary to protect capsules and their contents from shocks that occur during emergency braking, strong acceleration or from impact caused by minor vehicle collisions.

For capsules of rigid mechanical connections, the EV Pneumatic Battery Tubes (FIG. 13, Device 3) are housed in a battery casing. The tubes terminate in soft stopper bars that prevent the battery trains to exit during battery exchange. The electric plugs, that connect the battery capsule trains to the rest of the battery circuit and their associated ‘quick-couple’ guiding pins are incorporated in a retractable motorised lid. The other end of the tubes are closed by the battery exchange lid that incorporates elastomer bumpers in contact with the terminal capsules. Both lids are firmly closed and withstand steady maximum inertial force of 2400 N, less internal frictional forces, during exceptionally heavy braking of up to 1 g and even greater transient forces during vehicle collision.

The steps of the battery connection procedure during battery exchange are as follows.

Step 1. The lid is opened and the pneumatic tubes are attached. The retractable lids of the EV and of Device 4 are activated; the lids retract by about 5 cm, electrically disconnecting all the pneumatic battery capsule trains. The capsules are held firmly against the stopper bars when the electric connection pins are extracted from the sockets. The ‘quick-couple’ guiding pins remain inside the capsule sockets.

Step 2. The capsule trains are exchanged, and the ‘quick-couple’ guiding pins are inside the sockets of terminal capsules for both recharged batteries, on the EV, and discharged batteries on Device 4.

Step 3. The retractable lid of Device 4 moves back to its final position, while air pressure is stepped up, in turn, inside the pneumatic battery tubes of Device 4. The electric plugs are firmly inserted into the terminal capsule sockets.

Step 4. The retractable lid of EV moves back to its intermediate position, while air pressure is stepped up, in turn, inside the pneumatic battery tubes of EV's. The electric plugs are firmly inserted into the terminal capsule sockets. The battery exchange lid on EV is closed and the retractable lid of EV moves back its final position pressing the capsules firmly against the elastomer bumpers on the battery exchange lid.

Device 2 is now spring-loaded to prevent any displacements between sockets and plugs by inertial forces acting on Device 2, if the static spring force is greater than the maximum expected inertial force (10×9.81˜100 N), less frictional resisting force of the plug (˜50 N), less static sliding frictional force of Device 2 (˜50 N). The total maximum motorised spring force to be applied to the retractable lid is in excess of 24×100=2400 N.

The design of ‘quick-couple’ guiding pins that mechanically connects the retractable lids to Device 2 is a challenge. The design must prevent troublesome insertion of the plug. Impact damage to the contact points will lead to unreliable electric contacts and arching during vehicle operation.

3.4 Device 4

EV Battery Charging Rack (Device 4) is located at some distance from the battery exchange bay and can hold up to ten battery packs. Each pack is housed in the same number of EV Pneumatic Battery Tubes (Device 3) as those for the EV. The tubes are a part of the battery charging rack's thermal management system. Each tube is permanently connected to a pneumatic pipeline system that terminates at the battery exchange bay via pneumatic pipeline junctions.

For capsules of flexible mechanical connections, the far end of each tube or the far end of the capsule train is fitted with an identical solenoid-operated plug and a proximity switch to the one on the EV.

For capsules with rigid mechanical connections, the battery casing, is identical to the battery casing on the EV, except for the front lid which can be removed and the portholes can be connected to the pneumatic pipeline system. For capsules with rigid mechanical connections, it should be possible to use an EV with an identical battery pack on board to act as a mobile Device 4.

The rack is connected to mains electricity supply. Rate of charging, start time of charging and end time of charging is controlled by programmed microprocessor, which is a part of the rack's battery management system.

3.5 Modular Battery Pack

The terminals of the 24 EV Pneumatic Battery Tubes, via the solenoid connectors, are connected in parallel/series to form the EV's 36 kwh nominal energy capacity battery pack (3840 battery cells, 240 plus 24 battery capsules and 24 battery capsule trains. All-EV Pneumatic Battery Tubes must be the same capacity (Ah) same voltage and same state of charge.

A tentative choice of 16 cells connected in series and 10 cells connected in parallel would rate each EV Pneumatic Battery Tube at 60 volts and 25 Ah capacity, 6 EV Pneumatic Battery Tubes connected in series and 4 EV Pneumatic Battery Tubes connected in parallel would rate the battery pack at 360 volts and 100 Ah capacity. The pack, including the temperature control jacket, would weigh around 300 kg. The battery pack provides an estimated range of 240 km on full charge for an average electric car.

3.6 Pneumatic System

A tentative pneumatic capsule pipeline transport system requirement for exchanging the 36 kWh battery packs are two reverse action blowers (200-300 mbar pressure and up to 5-9 cubic metre/min air flow), two 3-way diverters, for shunting the the capsule trains in and out of the two sidings, two times seven 4-way diverters plus two 3-way diverters to provide independent air supply from the two blowers to the 24 portholes of the EV and to the 24 portholes of the battery charging rack. A schematic diagram shows the exchange process in FIG. 14. A single capsule train, exiting from one of the two 3-way diverters and entering the first 4-way diverter, can exit to one of the first set of 3 portholes or exit to the second 4-way diverter. From there, it can exit directly to one of the second set of 3 portholes (portholes 4, 5 and 6) or exit to the third 4-way diverter and so on all the way to the seventh 4-way diverter. From the seventh 4-way diverter, there are exits to portholes 19, 20 and 21 or to the 3-way diverter, which provides exits to one of the last three portholes 22, 23 and 24. The diverters can also be set for the flow of capsule trains in the opposite directions.

All the equipment is off-the-shelf (ref. 9) and their costs relative to the cost of a 36 kWh lithium ion battery pack is modest. If weather protection is provided, the equipment can be located in any desirable way inside or outside buildings in the vicinity of the battery exchange bay or away from it. It should possible to accommodate the bundle of 24 pipelines that lead to the battery exchange bay inside an underground conduit of less than 0.20 square metre cross section area.

### EMBODIMENTS

1. A modular EV battery exchange system, used for the exchange of encapsulated, electrically and mechanically connected (device 1 & device 2) discharged EV battery pack or the exchange of encapsulated, electrically and mechanically connected (device 1 & device 2) faulty EV battery pack for an identical fully charged EV battery pack or for an identical EV battery pack in full working order, using evacuated or compressed air inside a pneumatic pipeline system, connected to EV pneumatic battery tubes (device 3) on board of EV and also connected to EV pneumatic battery tubes (device 3) on EV pneumatic battery charging rack (device 4) at an EV battery exchange station or at an EV battery service station.

2. Device 1, as specified in embodiment 1 above, that encapsulates EV battery cells or EV battery modules and is an integral part of the said EV modular battery exchange system.

3. Device 2, as specified in embodiment 1 above, that electrically and mechanically connects together two or more devices 1, as specified in embodiment 1 above, and is an integral part of the said EV modular battery exchange system.

4. Device 3, as specified in embodiment 1 above, that houses device 4, as specified in embodiment 1 above, on board EV or on device 4 and is an integral part of the said EV modular battery exchange system.

5. Device 4, as specified in embodiment 1 above, that houses one or more such devices 3 and is an integral part of the said EV modular battery exchange system.

It will be appreciated by those skilled in the art that several variations are envisaged without departing from the scope of the invention. For example, the pipework system 43 may be configured to selectively extract one train of spent capsules 2, or even a single spent capsule 2, at a time to simplify the configuration of thereof. It will also be appreciated that the replacement of some but not all capsules 2 or trains of capsules 2 will provide a partial re-charging of the capacity of the vehicle 3. Advantageously, the battery 1 may be configured to function with some, but not all, capsules 2 or trains of capsules 2 rather than leaving spent capsules therein when a less than complete charge is required.

Moreover, the vehicle 3 may comprise two or more batteries 1 and/or each battery may comprise more or less capsules 2 or trains of capsules 2 or tubes and/or each capsule 2 may comprise more or less rechargeable cells 20 than disclosed in the exemplary embodiment described above.

It will also be appreciated that the configuration of the capsule connectors 22, 23 result in the capsules moving along the pneumatic pathways in a singular fashion rather than in chains. This is expected to reduce wear on connections as well as reducing the minimum bend radius of the flexible portion 41 of the pipes 40. The pipework system 43 may advantageously comprise a plurality of blowers 44, which need not but are preferably reversible, and/or a plurality of diverters for directing the capsules as described above or in any other suitable or desirable fashion.

It will be appreciated by those skilled in the art that any number of combinations of the aforementioned features and/or those shown in the appended drawings provide clear advantages over the prior art and are therefore within the scope of the invention described herein.

1. A rechargeable battery for powering an electric vehicle, the battery comprising at least one removable and replaceable electrically rechargeable cell, wherein the cell is encapsulated within a capsule compatible with transport along a pipeline.

2. Battery according to claim 1, wherein the capsule is compatible with pneumatic transport along a pipeline.

3. Battery according to claim 1 further comprising a plurality of electrically rechargeable cells encapsulated within the capsule, wherein the capsule is removable and replaceable with respect to the battery.

4. Battery according to claim 3 further comprising a plurality of electrically interconnected capsules each with a plurality of electrically rechargeable cells in electrical contact encapsulated therein, wherein each capsule is compatible with transport along a pipeline.

5. Battery according to claim 4, wherein the plurality of capsules comprises first and second types of capsules, the first capsule type including an electrical terminal connector configured to cooperate with the electrical terminal connector of another first capsule type to provide a series connection and the second capsule type including an electrical terminal connector configured to cooperate with the electrical terminal connector of another second capsule type to provide a series connection, wherein the electrical terminal connectors of the first and second capsule type are configured to connect the first and second capsules in parallel.

6. Battery according to claim 1, wherein the capsule comprises first and second concentric electrical terminals at either end thereof.

7. A capsule of electrically rechargeable cells suitable for use within a battery according to claim 1, which capsule comprises a receptacle in which the cell or cells are housed, an electrical terminal at each end of the capsule and at least one circumferential collar for facilitating transport, in use, along a pipeline.

8. Capsule according to claim 6, wherein the at least one collar is configured to cooperate with a pipeline through which the capsule is transported, in use, to guide and/or substantially seal therewith.

9. Capsule according to claim 7, wherein the at least one circumferential collar comprises two circumferential collars.

10. Capsule according to claim 7 further comprising a pair of electrical terminals at each end of the capsule.

11. Capsule according to claim 10 further comprising a switching means for selectively switching, in use, the contact between the pair of terminals at one end of the capsule with those at the other end of the capsule.

12. Capsule according to claim 11, wherein the switching means comprises one or more solid state switches.

13. An electrically powered vehicle comprising a rechargeable battery according to claim 1.

14. Vehicle according to claim 13, wherein the battery comprises an array of tubing within which capsules can be located.

15. Vehicle according to claim 13 further comprising at least one displacement pipeline through which capsules can be transported to and from its rechargeable battery or batteries.

16. Vehicle according to claim 15, wherein the displacement pipeline is pneumatically compatible.

17. An electric vehicle service and/or charging station compatible for use with an electrically powered vehicle according to claim 13, in that it comprises a charging receptacle within which capsules can be temporarily stationed for recharging, and pipelines able to couple with said electric vehicle in a manner to receive and transport said capsules.

18. A repository of multiple capsules according to claim 7, adapted for use with an electric vehicle service and/or charging station in that it comprises pipelines in communication with said service and/or charging station and a stock of capsules.

19. A system of apparatus capable of pneumatically withdrawing from an electric vehicle rechargeable battery one or more capsules according to claim 7.

20. A method of charging or recharging at least one rechargeable battery within an electric vehicle, which comprises pneumatically removing from said battery at least one discharged, partly discharged or faulty capsules according to claim 7, and pneumatically replacing it with another like such capsules in a charged and/or otherwise operational state.

21. A method according to claim 19, which involves use of a service and/or charging station.
